(19) United States
(12) Patent Application Publication
(10) Pub. No.: US 2024/0031036 A1
(43) Pub. Date: Jan. 25, 2024

(54) OPTICAL MODULE, WAVELENGTH ADAPTIVE COHERENT OPTICAL COMMUNICATION METHOD, AND COMPUTER STORAGE MEDIUM

(71) Applicant: InnoLight Technology (Suzhou) Ltd., Suzhou City (CN)

(72) Inventors: Xuezhe ZHENG, Jiangsu (CN); Zhe XIA, Jiangsu (CN); Yan JI, Jiangsu (CN)

(21) Appl. No.: 18/481,245

(22) Filed: Oct. 5, 2023

Related U.S. Application Data
(63) Continuation of application No. PCT/CN2021/133396, filed on Nov. 26, 2021.

(30) Foreign Application Priority Data
Jun. 29, 2021 (CN) 202110723956.4

(51) Int. Cl. H04B 10/61

(52) U.S. Cl. CPC H04B 10/6164

(57) ABSTRACT

Provided in the present disclosure are an optical module, a wavelength adaptive coherent optical communication method, and a computer storage medium, the optical module comprising: a local oscillator laser, used for outputting local oscillator light; a receiving module, used for receiving an input light signal and a local oscillator light signal; a mixing module, used for mixing the input light signal and the local oscillator light signal to obtain a beat frequency signal; and a digital signal processing module, at least configured to be used for calculating the beat frequency signal frequency and, by means of a feedback control loop, adjusting the local oscillator light frequency outputted by the local oscillator laser according to the beat frequency signal frequency.

### CROSS-REFERENCE TO RELATED PATENT APPLICATION

This application is a continuation application of International patent application Ser. No. PCT/CN2021/133396, filed on Nov. 26, 2021, which the international application was published on Jan. 5, 2023, as International Publication No. WO 2023/273129A1, and claims the priority of China Patent Application No. 202110723956.4, filed on Jun. 29, 2021, in People's Republic of China. The entirety of each of the above patent applications is hereby incorporated by reference herein and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to the field of coherent optical communication, in particular to an optical module, a wavelength adaptive coherent optical communication method and a computer storage medium.

### BACKGROUND OF THE DISCLOSURE

With the rapid development of big data, the Internet of Things and 5G services, the demand for network capacity is increasing rapidly, making coherent optical communication technology with large bandwidth and long- distance transmission the first choice for the next generation of high-speed and large-capacity optical networks. As a highly coherent light source and local oscillator, narrow-linewidth tunable lasers have become one of the core devices for coherent optical communications. At present, narrow-linewidth tunable lasers are mainly DBR, DFB, and ECL, etc., but as the service life decreases, the output frequency will inevitably shift, so that the optical frequency deviation with the local oscillator of the optical module will increase and affect the optical module. In addition, high-precision, high-precision frequency and high-stability light sources require high-precision temperature control or current control capabilities, and the manufacturing processes are difficult and expensive.

SUMMARY OF THE DISCLOSURE

The object of the present disclosure is to provide an optical module, a wavelength adaptive coherent optical communication method and a computer storage medium.

The present disclosure provides a wavelength adaptive optical module, including:

a local oscillator laser configured to output a local oscillator light,

a receiving module configured to receive an input light signal and a local oscillator light signal,

a mixing module configured to mix the input light signal and the local oscillator light signal to obtain a beat frequency signal, and

a digital signal processing module at least configured to calculate a beat frequency signal frequency of the beat frequency signal, and adjust the local oscillator light frequency output by the local oscillator laser through a feedback control loop according to the beat frequency signal frequency.

As a further improvement of the present disclosure, the optical module further includes a digital-to-analog conversion module, the digital-to-analog conversion module is configured to convert a signal mixed by the mixing module into a digital signal, and send the digital signal to the digital signal processing module.

As a further improvement of the present disclosure, a formula for calculating a mixing signal I_{beat} of the beat frequency signal frequency by the digital signal processing module is:

I_{beat}(t)=I_{Lo}+I_{S}+2m\sqrt{I_{LO}·I_{S}} cos (2πf_{IF}t+(θ_{LO}−θ_{S}))

f_{IF}f_{LO}−f_{S},

in which I_{LO} is an optical intensity of the local oscillator light signal, Iₛ is an optical intensity of the input light signal, m is a mixing efficiency of the local oscillator light and the input light, f_{IF} is a beat frequency signal frequency, f_{LO} is a local oscillator light frequency, θ_{LO} is an initial phase of the local oscillator light, f_{S} is an input light frequency, θ_{S} is an initial phase of the input light, and a frequency difference between the local oscillator light and the input light is obtained by measuring f_{IF} through the formula.

As a further improvement of the present disclosure, the digital signal

processing module is configured as:

when a value of the beat frequency signal frequency is greater than a preset threshold value, a beat frequency signal frequency of the local oscillator light is adjusted to be less than the preset threshold value.

As a further improvement of the present disclosure, the digital signal processing module is configured as:

when the beat frequency signal frequency is not zero, the digital-to-analog conversion module generates a control signal to adjust the local oscillator light frequency until the beat frequency signal frequency is equal to zero.

The present disclosure also provides a wavelength adaptive coherent optical communication method, including processes of:

mixing an input light signal and a local oscillator light signal to obtain a beat frequency signal, and

calculating a beat frequency signal frequency of the beat frequency signal, and adjusting a local oscillator light frequency according to the beat frequency signal frequency.

As a further improvement of the present disclosure, in the process of “calculating a beat frequency signal frequency,” a formula for calculating a mixing signal /beat of the beat frequency signal frequency is:

I_{beat}(t)=I_{Lo}+I_{S}+2m\sqrt{I_{LO}·I_{S}} cos (2πf_{IF}t+(θ_{LO}−θ_{S}))

f_{IF}f_{LO}−f_{S},

in which I_{LO} is an optical intensity of the local oscillator light signal, Iₛ is an optical intensity of the input light signal, m is a mixing efficiency of the local oscillator light and the input light, f_{IF} is a beat frequency signal frequency, f_{LO} is a local oscillator light frequency, θ_{LO} is an initial phase of the local oscillator light, f_{S} is an input light frequency, and θ_{S} is an initial phase of the input light.

As a further improvement of the present disclosure, “adjusting a local oscillator light frequency according to the beat frequency signal frequency” specifically includes:

when the beat frequency signal frequency is greater than a preset threshold, the local oscillator light frequency is adjusted until the beat frequency signal frequency is smaller than the preset threshold.

As a further improvement of the present disclosure, “adjusting a local oscillator light frequency according to the beat frequency signal frequency” specifically includes:

when the beat frequency signal frequency is not zero, the digital-to-

analog conversion module generates a control signal to adjust the local oscillator light frequency until the beat frequency signal frequency is equal to zero.

The present disclosure also provides a computer storage medium, in which a computer program is stored, and when the computer program runs, a device where the computer storage medium runs executes the aforementioned processes of the wavelength adaptive coherent optical communication method.

A beneficial effect of the present disclosure is: the optical module and the wavelength adaptive coherent optical communication method provided by the present disclosure can obtain the frequency difference between the local oscillator light signal and the input light signal by calculating in real time the beat frequency signal frequency obtained after mixing the local oscillator light signal and the input light signal, and adjust the local oscillator light signal frequency in real time according to the frequency difference, so that the frequency difference between the local oscillator light frequency and the input light signal is maintained within a small range, and the wavelength adaptive coherent link is implemented, so as to reduce the requirements on the frequency accuracy and stability of the input light.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of the principle of an optical module in an embodiment of the present disclosure.

FIG. 2 is a schematic diagram of processes of a wavelength adaptive coherent optical communication method in an embodiment of the present disclosure.

FIG. 3 is a structural block diagram of an optical module in an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to make the purpose, technical solution and advantages of the present disclosure clearer, the following will clearly and completely describe the technical solution of the present disclosure in combination with specific implementation methods of the present disclosure and corresponding drawings. Apparently, the described implementations are only some of the implementations of the present disclosure, not all of them. Based on the implementation manners in the present disclosure, all other implementation manners obtained by persons of ordinary skill in the art without making creative efforts belong to the scope of protection of the present disclosure.

Embodiments of the present disclosure are described in detail below, and examples of the embodiments are shown in the drawings, in which the same or similar reference numerals denote the same or similar elements or elements having the same or similar functions throughout. The embodiments described below by referring to the figures are exemplary only for explaining the present disclosure and should not be construed as limiting the present disclosure.

For the convenience of description, terms representing relative positions in space are used herein for description, such as “upper”, “lower”, “rear”, “front”, etc., which are used to describe the relationship of one element or feature to another element or feature shown in a drawing. Spatially relative terms may encompass different orientations of the device in use or operation other than the orientation shown in the figures. For example, if the device in the figures is turned over, elements described as “below” or “above” other elements or features would then be oriented “below” or “above” the other elements or features. Thus, the exemplary term “below” can encompass both a spatial orientation of below and above.

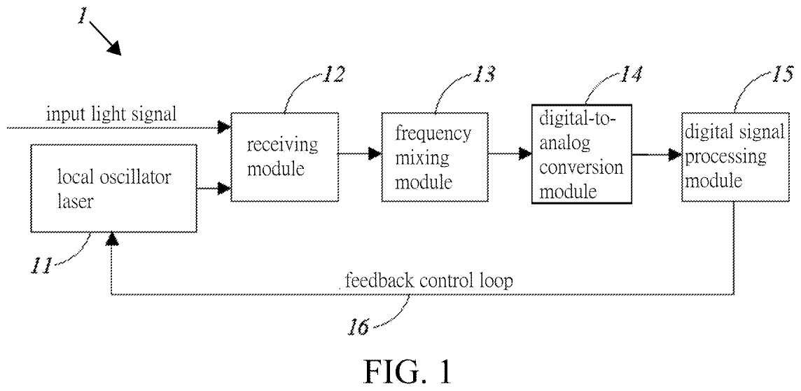

Reference is made to FIG. 1, which is a simplified schematic diagram of the principle of an optical module 1 provided by the present disclosure. The optical module is applied to a coherent optical communication system, which includes: a local oscillator laser 11, a receiving module 12, a mixing module 13, a digital-to-analog conversion module 14, a digital signal processing module 15 and a feedback control loop 16.

A transmitting unit modulates a transmitted electrical signal onto an optical carrier, forms a transmitted input light signal through signal encoding and polarization control, and transmits the transmitted input light signal to the optical module 1 through an optical fiber.

The local oscillator laser 11 is configured to output a local oscillator light, and a light wave of the local oscillator light is matched with a wavefront and polarization of a received input light for mixing with the input light signal.

The receiving module 12 is configured to receive an input light signal and a local oscillator light signal.

The mixing module 13 is configured to mix the input light signal and the local oscillator light signal to obtain a beat frequency signal. After the beat frequency signal is further subjected to photoelectric detection, amplification and filtering, the beat frequency signal is converted into a digital signal by the digital-to-analog conversion module 14, and the digital signal is sent to the digital signal processing module 15.

The digital signal processing module 15 processes the digital signal. In this embodiment, in addition to functions such as conventional demodulation of light signals, the digital signal processing module is at least configured to calculate a beat frequency signal frequency, and adjust a local oscillator light frequency output by the local oscillator laser 11 through the feedback control loop 16 according to the beat frequency signal frequency.

Specifically, in this embodiment, the formula for calculating the mixed frequency signal heat of the beat frequency signal frequency by the digital signal processing module 15 is:

I_{beat}(t)=I_{Lo}+I_{S}+2m\sqrt{I_{LO}·I_{S}} cos (2πf_{IF}t+(θ_{LO}−θ_{S}))

f_{IF}f_{LO}−f_{S},

in which I_{LO} is an optical intensity of the local oscillator light signal, I_{S} is an optical intensity of the input light signal, m is a mixing efficiency of the local oscillator light and the input light, f_{iF} is a beat frequency signal frequency, f_{LO} is a local oscillator light frequency, θ_{LO} is an initial phase of the local oscillator light, f_{S} is an input light frequency, and θ_{S} is an initial phase of the input light.

In the above formula, the optical intensity, frequency, initial phase, and mixing efficiency of the input light signal and the local oscillator light signal are constant. Therefore, in addition to the DC term representing the optical intensity of the local oscillator light and signal light in the mixed frequency signal, there is also a relative low-frequency AC signal determined by the frequency difference between the local oscillator light and the signal light, that is, the so-called beat frequency signal. By measuring and calculating a beat frequency signal frequency, the frequency difference between the local oscillator light and the signal light can be obtained.

Further, in certain embodiment of the present disclosure, the digital signal processing module 15 is configured to: when the difference between the sum of the optical intensity I_{LO} of the local oscillator light signal and the optical intensity I_{S} of the input light signal and the intensity of the beat frequency signal frequency I_{beat} is greater than a preset threshold, the local oscillator light frequency is adjusted through the feedback control loop 16 until the difference between the two is less than the preset threshold.

When there is a frequency difference between the local oscillator light signal and the input light signal, the digital signal processing module 15 can eliminate the influence of the frequency difference through methods such as phase estimation algorithms. However, when the frequency difference is too large, the excessive frequency deviation will affect the performance of the signal processing algorithm of the digital signal processing module 15. In addition, as the service life decreases, the output frequency of the transmitting unit inevitably shifts, thereby increasing the deviation of the local oscillator light frequency and affecting the performance of the optical module 1. Therefore, when the beat frequency signal optical frequency calculated by the above formula exceeds the preset threshold, the local oscillator light frequency can be adjusted in real time through the feedback control loop 16 to reduce the frequency difference, so that the local oscillator light signal matches the input light signal frequency, thereby reducing the requirements on the frequency accuracy and stability of the input light. The preset threshold mentioned here is a maximum value of the frequency difference at which the digital signal processing module 15 can effectively eliminate the influence of the frequency difference.

Further, in one embodiment of the present disclosure, the digital signal processing module 15 is configured to: when the beat frequency signal frequency is not zero, the digital-to-analog conversion module 14 generates a control signal to adjust the local oscillator light frequency until the beat frequency signal frequency is equal to zero.

The performance of the signal processing algorithm of the digital signal processing module 15 can be further improved by adjusting the local oscillator light signal frequency to be consistent with the input light in real time.

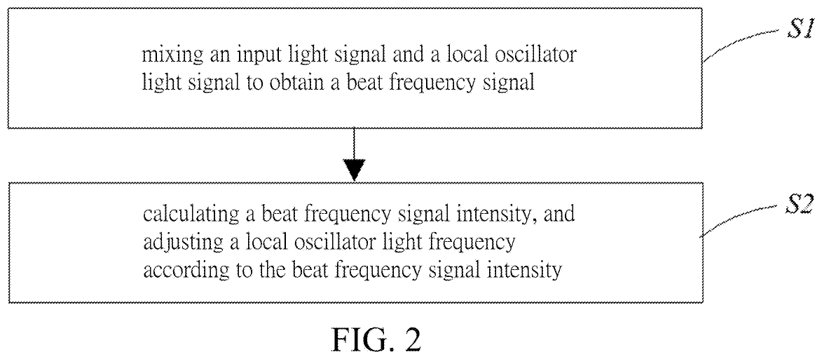

As shown in FIG. 2, the present disclosure further provides a wavelength adaptive coherent optical communication method, including processes of:

S1: mixing an input light signal and a local oscillator light signal to obtain a beat frequency signal, and

S2: calculating a beat frequency signal frequency of the beat frequency signal and adjusting a local oscillator light frequency according to the beat frequency signal frequency.

Specifically, the formula for calculating the mixed frequency signal I_{beat} of the beat frequency signal frequency is:

I_{beat}(t)=I_{Lo}+I_{S}+2m\sqrt{I_{LO}·I_{S}} cos (2πf_{IF}t+(θ_{LO}−θ_{S}))

f_{IF}f_{LO}−f_{S},

in which I_{LO} is an optical intensity of the local oscillator light signal, I_{S} is an optical intensity of the input light signal, m is a mixing efficiency of the local oscillator light and the input light, f_{iF} is a beat frequency signal frequency, f_{LO} is a local oscillator light frequency, θ_{LO} is an initial phase of the local oscillator light, f_{S} is an input light frequency, and θ_{S} is an initial phase of the input light.

Further, in certain embodiment of the present disclosure, when the frequency of the mixing signal frequency is greater than a preset threshold, the digital-to-analog conversion module 14 generates a control signal to adjust the local oscillator light frequency until the difference between the two is less than the preset threshold.

Further, in certain embodiments of the present disclosure, when the beat frequency signal frequency is not zero, the digital-to-analog conversion module 14 generates a control signal to adjust the local oscillator light frequency until the beat frequency signal frequency is equal to zero.

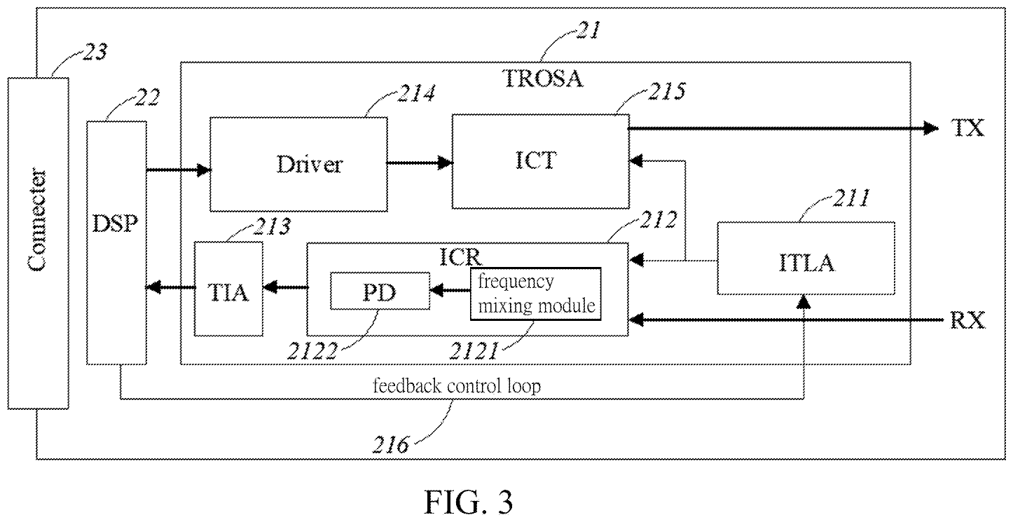

Reference is made to FIG. 3, which is a structural block diagram of an optical module exemplified in an embodiment of the present disclosure. The optical module 1 includes a transmitting optical sub-assembly 21 (TROSA), a digital signal processing module 22 (DSP), and a connector 23 (Connector), etc. The electronic active part of the transmitting optical sub-assembly 21 includes: an integrateable tunable laser assembly 211 (ITLA), an interpolation coherent receiver 212 (ICR) belonging to the receiving end RX circuit, and a transimpedance amplifier 213 (TIA), etc., which belong to the driver chip 214 (Driver) and the coherent transmitter 215 (ICT) of the transmitter circuit. The interpolation coherent receiver 212 includes a mixing module 2121 and a high-speed photodiode 2122 (PD), etc., and the mixing module 2121 and the digital signal processing module 22 implement the above coherent optical communication method. In addition, the optical module further includes a feedback control loop 216 connected between the digital signal processing module 22 and the integrateable tunable laser assembly 211. The digital signal processing module 22 outputs a control signal to the integrateable tunable laser assembly 211 through the feedback control loop 216 to adjust the optical frequency of the local oscillator light signal.

The present disclosure further provides a computer storage medium, in which a computer program is stored, and when the computer program runs, the device where the computer storage medium resides executes the processes of the above wavelength adaptive coherent optical communication method.

In summary, the wavelength adaptive optical module and the wavelength adaptive coherent optical communication method provided by the present disclosure can calculate the beat frequency signal frequency obtained after mixing the local oscillator light signal and the input light signal in real time to obtain the frequency difference between the local oscillator light signal and the input light signal. Therefore, the local oscillator light frequency is adjusted in real time to be consistent with the input light signal frequency, thereby implementing the wavelength adaptation and reducing the requirements for the precision and stability of the input light frequency.

It should be understood that although this description is described according to implementation modes, not every one of the implementation modes contains only one independent technical solution, and the way of description in the present disclosure is only for the sake of clarity, and those skilled in the art should take the description as a whole, with each of the technical solutions in the embodiments being capable of being appropriately combined to form other embodiments that can be understood by those skilled in the art.

The series of detailed specifications listed above are only specific specifications of the feasible implementation modes of the present disclosure, and they are not intended to limit the protection scope of the present disclosure. Any equivalent implementation mode or all changes should be included within the scope of protection of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical module, comprising:
a local oscillator laser configured to output a local oscillator light;
a receiving module configured to receive an input light signal and a local oscillator light signal;
a mixing module configured to mix the input light signal and the local oscillator light signal to obtain a beat frequency signal; and
a digital signal processing module at least configured to calculate a beat frequency signal frequency of the beat frequency signal, and adjust the local oscillator light frequency output by the local oscillator laser through a feedback control loop according to the beat frequency signal frequency.

2. The optical module according to claim 1, wherein the optical module further comprises a digital-to-analog conversion module, the digital-to-analog conversion module is configured to convert a signal mixed by the mixing module into a digital signal, and the digital signal is sent to the digital signal processing module.

3. The optical module according to claim 2, wherein a formula for calculating a mixing signal /beat of the beat frequency signal frequency by the digital signal processing module is:
I_{beat}(t)=I_{Lo}+I_{S}+2m\sqrt{I_{LO}·I_{S}} cos (2πf_{IF}t+(θ_{LO}−θ_{S}))
f_{IF}f_{LO}−f_{S},
wherein, I_{LO} is an optical intensity of the local oscillator light signal, I_{S} is an optical intensity of the input light signal, m is a mixing efficiency of the local oscillator light and the input light, f_{IF} is a beat frequency signal frequency, f_{LO} is a local oscillator light frequency, θ_{LO} is an initial phase of the local oscillator light, f_{S} is an input light frequency, θ_{S} is an initial phase of the input light, and a frequency difference between the local oscillator light and the input light is obtained by measuring f_{IF} through the formula.

4. The optical module according to claim 3, wherein the digital signal processing module is configured as:
when a value of the beat frequency signal frequency is greater than a preset threshold value, the digital-to-analog conversion module generates a control signal to adjust the local oscillator light frequency until a beat frequency signal frequency is less than the preset threshold value.

5. The optical module according to claim 3, wherein the digital signal processing module is configured as:
when the beat frequency signal frequency is not zero, the digital-to-analog conversion module generates a control signal to adjust the local oscillator light frequency until the beat frequency signal frequency is equal to zero.

6. A wavelength adaptive coherent optical communication method, comprising processes of:
mixing an input light signal and a local oscillator light signal to obtain a beat frequency signal; and calculating a beat frequency signal frequency of the beat frequency signal, and adjusting a local oscillator light frequency according to the beat frequency signal frequency to make a frequency of the input light signal to be consistent with the local oscillator light frequency as possible.

7. The wavelength adaptive coherent optical communication method according to claim 6, wherein in the process of calculating a beat frequency signal frequency, a formula for calculating a mixing signal I_{beat} of the beat frequency signal frequency is:
I_{beat}(t)=I_{Lo}+I_{S}+2m\sqrt{I_{LO}·I_{S}} cos (2πf_{IF}t+(θ_{LO}−θ_{S}))
f_{IF}f_{LO}−f_{S},
wherein, I_{LO} is an optical intensity of the local oscillator light signal, I_{S} is an optical intensity of the input light signal, m is a mixing efficiency of the local oscillator light and the input light, f_{IF} is a beat frequency signal frequency, f_{LO} is a local oscillator light frequency, θ_{LO} is an initial phase of the local oscillator light, f_{S} is an input light frequency, and θ_{S} is an initial phase of the input light.

8. The wavelength adaptive coherent optical communication method according to claim 7, wherein the process of adjusting a local oscillator light frequency according to the beat frequency signal frequency comprises:
when the beat frequency signal frequency is greater than a preset threshold, a digital-to-analog conversion module generates a control signal to adjust the local oscillator light frequency until a difference between the frequency of the input light signal and the local oscillator light frequency is smaller than the preset threshold.

9. The wavelength adaptive coherent optical communication method according to claim 7, wherein the process of adjusting a local oscillator light frequency according to the beat frequency signal frequency specifically comprises:
when the beat frequency signal frequency is not zero, the digital-to-analog conversion module generates a control signal to adjust the local oscillator light frequency until the beat frequency signal frequency is close to or equal to zero.

10. A computer storage medium, wherein a computer program is stored therein, and when the computer program runs, a device where the computer storage medium runs executes the processes of the wavelength adaptive coherent optical communication method according to claim 6.
